(19) United States
(12) Patent Application Publication
(10) Pub. No.: US 2025/0131471 A1
(43) Pub. Date: Apr. 24, 2025

(54) Surfacing Cross-Channel Data for Impression Reporting

(71) Applicant: Google LLC, Mountain View, CA (US)

(72) Inventors: Matthew Aaron Jacobson, Scarsdale, CA (US); Yuval Segal, New York, NY (US); Alman Shibli, Hoboken, NJ (US); Saurav Mohapatra, Orinda, CA (US)

(21) Appl. No.: 19/005,505

(22) Filed: Dec. 30, 2024

Related U.S. Application Data
(60) Provisional application No. 63/349,790, filed on Jun. 7, 2022.

(51) Int. Cl. G06Q 30/0242

(52) U.S. Cl. CPC G06Q 30/0246

(57) ABSTRACT

Computing systems and methods for surfacing impression data are disclosed herein. The method can include periodically providing a reporting data request to one or more data sources requesting impression data associated with content presented at the data sources. Reporting data is received and processed into a data format usable by the database. The reporting data is then saved in a database. In response to receiving a request from a user to generate a report the reporting data stored in the database is processed using a machine-learned model to generate a model output, and a portion of the reporting data and the model output are output for display to the user.

### PRIORITY

The present application claims the benefit of priority of U.S. Provisional Patent Application No. 63/349,790 filed on May 20, 2024, which is incorporated by reference herein.

### FIELD

The present disclosure relates generally to cross-channel data aggregation for impression reporting.

### BACKGROUND

Cross-channel content providers find that users are engaging with their content actively and passively across numerous publishers and channels, such as the displaying of content on social media, retail websites, as video content, and the like. These content providers need a way to measure the reach of their content in driving their performance goals so that they have the most complete understanding of the impact of their content.

Today, existing cross-channel performance measurement only allows content providers to evaluate the effectiveness of clicks on driving downstream conversions, or desirable actions resulting from a user encountering the content. This click-centric measurement undervalues the effectiveness of content being presented on touchpoints across formats, channels, publishers that influence user behavior without directly inducing user clicks on the content.

As a result, larger, sophisticated content providers often rely heavily on a mix of internal tools with custom weighting and discounting models and measurement providers which may not measure media consumption fairly or accurately. Smaller providers that may be new to impression tracking often do not have the time or resources to invest in understanding the true impact of content presentation and thus may be making suboptimal decisions preventing them from reaching a larger audience.

### SUMMARY

Aspects and advantages of embodiments of the present disclosure will be set forth in part in the following description, or can be learned from the description, or can be learned through practice of the embodiments.

One example aspect of the present disclosure is directed to a computing system. The computing system can comprise one or more processors, a database, and a non-transitory, computer-readable medium storing instructions that, when executed by the one or more processors, cause the one or more processors to perform operations. The operations can comprise periodically providing a reporting data request to each data source of a plurality of data sources, the reporting data request requesting data indicative of a number of impressions associated with content provided to the plurality of data sources and receiving reporting data from the plurality of data sources in response to the reporting data request. The operations can also comprise processing the reporting data into a data format usable by the database and storing the reporting data in the database. In response to receiving a request from a user to generate a report, the operations an comprise processing the reporting data stored in the database using a machine-learned model to generate a model output, wherein the model output is indicative of one or more actions a user can take based on the reporting data and outputting at least a portion of the reporting data and the model output for display to the user.

Another example aspect of the present disclosure is directed to a computer-implemented method. The method can comprise periodically providing, by one or more processors of a computing system, a reporting data request to each data source of the plurality of data sources, the reporting data request requesting data indicative of a number of impressions associated with content provided to the plurality of data sources and receiving, by the one or more processors, reporting data from the plurality of data sources in response to the reporting data request. The method can also comprise processing, by the one or more processors, the reporting data into a data format usable by the database and storing, by the one or more processors, the reporting data in the database. In response to receiving a request from a user to generate a report, the method can comprise processing, by the one or more processors, the reporting data stored in the database using a machine-learned model to generate a model output, wherein the model output is indicative of one or more actions a user can take based on the reporting data and outputting, by the one or more processors, at least a portion of the reporting data and the model output for display to the user.

Another example aspect of the present disclosure is directed to a non-transitory, computer-readable medium storing instructions that, when executed by one or more processors, cause the one or more processors to perform operations. The operations can comprise periodically providing a reporting data request to each data source of a plurality of data sources, the reporting data request requesting data indicative of a number of impressions associated with content provided to the plurality of data sources and receiving reporting data from the plurality of data sources in response to the reporting data request. The operations can also comprise processing the reporting data into a data format usable by the database and storing the reporting data in the database. In response to receiving a request from a user to generate a report, the operations an comprise processing the reporting data stored in the database using a machine-learned model to generate a model output, wherein the model output is indicative of one or more actions a user can take based on the reporting data and outputting at least a portion of the reporting data and the model output for display to the user.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a first data flow according to example embodiments of the present disclosure.

FIG. 1B depicts a second data flow according to example embodiments of the present disclosure.

FIG. 1C depicts a third data flow according to example embodiments of the present disclosure.

FIG. 2 depicts a block diagram of a content management system according to example embodiments of the present disclosure.

FIG. 3 depicts a flow chart diagram of an example method according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

Today, attribution scopes are fragmented across various reporting and analysis tools. An attribute scope is the user-visible representation of a filtering criteria applied to an attribution perimeter, defining the channels or touchpoints that are incorporated into attribution. An attribution perimeter is a representation of a superset, or group, of touchpoints used when calculating attribution, or giving credit to placement of content for realizing a goal of a content campaign. The attribution perimeter is not directly exposed to end users. Attribution parameters are modeled using attribution models, which are user-visible methodologies used to distribute attribution credit across a set of touchpoints. Examples of models include: “last click”, “last engagement”, “data-driven attribution (DDA),” and the like.

Content providers can be shoehorned into a limited view of attribution across a variety of content presentation platforms or other data sources. These limitations decrease trust in measurement of content impressions and, therefore, do not allow for ideal insight into the effectiveness of content campaigns across multiple platforms, media types, and viewership numbers.

Aspects of the proposed invention can address these problems by providing neutral, consistent, cross-channel, full-funnel content impression performance measurement. In particular, aspects of the proposed invention can include aggregating impression reporting in content provision workspaces by leveraging content provision workspace to campaign management platform links to pull campaign-level aggregate impressions via query-time widening and by implementing a low-friction automated cost data import workflow integrated directly with content provision platform reporting APIs. The use of these features enables a user to holistically view the impact of content provided by the user across multiple content presentation channels or data sources.

To aggregate impression reporting, unified conversions can be collected as a metric. Conversions can be measured as a metric measuring actions taken in response to a user viewing a content item. For example, a conversion can be counted when a user views a content item and then takes an action considered valuable to the provider of the content item, such as interacting with websites or other resources associated with the provider of the content item or performing a desired action, such as purchasing an item or subscribing to future content created by the provider.

When viewing a conversion performance report in an content provision workspace, content providers linked to campaign management platforms will have the ability to select a tracking configuration for tracking conversions (e.g., by tracking users and their interactions with content items using cookie identifications and/or device identifications) and one or more tagged activities to be tracked, such as tracking when a user views a particular content item and later accesses the website or another resource associated with the displayed content item.

Campaign management platforms are generally utilized by content provision agencies, while content provision platforms are generally used by individual content providers. Agencies are not typically given access to content provision platforms of individual content providers, and on the direct content provider side, the two products are typically managed by different teams. For complex cross-channel content providers with agency relationships, there is currently no way to directly discuss performance of content items or content campaigns through shared metrics.

Achieving unified conversions allows a user to see consistent conversion reporting metrics regardless of the frontend product or measurement surface being used once the user selects a conversion counting methodology. Across existing content provision platforms, a plurality of attribution scopes can be supported, which map one-to-one to distinct attribution perimeters. Consolidating attribute scopes into a singular scope enables retention of all existing user-visible attribution scopes and models in a way that causes zero impact to existing content provision systems and introduces new functionality (e.g. the creation of a new scope that incorporates impressions). To create the new scope, aspects of the invention include upgrading existing attribution scopes to incorporate both internal impressions collected by the content provider and impressions gathered from third parties where content items are placed.

To unify the attribution scopes, data can be obtained from content provision platform to campaign management platform links and via publisher-provided event-level user-keyed impressions from third parties. Users can leverage campaign management platform trafficking tags for their tracked content items and can have user interface elements of content provision platforms tagged with conversions caused by impressions from these data sources. The new attribution scope can gain visibility into all campaign management platform tracked touchpoints (e.g., impressions) based on the presence of linking between the content provision platform and the campaign management platform. Attribution scopes and models can be chosen to surface impression data to content providers based on contextual relevance of the impression data. As an example, default attribution can be defined as having an attribution scope of “filter touchpoints to include paid channels only” and having an attribution model of “distribute attribution credit via the heuristic: ‘100% to the last click if a click exists, otherwise 100% to the last impression’”. It is advantageous to surface this combination of attribution scope and model in both content provision platforms and campaign management platform user interfaces to support a consistent reporting experience.

Content providers can have their user interfaces tagged with content provision platform conversions but may not have a campaign management platform account or may not be using campaign management platform trafficking tags. To manage conversions for both content provision platforms and campaign management platforms, a Trusted execution environment (TEE) can be used. The TEE can be a software layer that exists on a computing system between publishers (e.g., social media sites, news sites) or other data sources for data associated with impressions of displayed content items and content provision platforms or campaign management platforms. The TEE can be responsible for ingesting publisher-provided event-level user-keyed impression data and translating publisher-provided user identifiers into metrics and data formats compatible with the content provision platform.

The TEE can act as an open endpoint to a content provision platform and can both access and be accessed by multiple publishers. To establish communications, the TEE can transmit a standard lightweight term of service that outlines how publisher-provided data may be used by the content provision platform. A communication connection can be established when publishers accept the terms of service.

Once a publisher accepts the terms of service, the publisher can be provided with a unique token that will be used to begin sending event-level impression data to the TEE endpoint.

A content provider can authenticate to their publisher account for various publishers by, for example, providing credentials authenticating the identity of the content provider from the TEE to the publisher.

The per-property or per-publisher authentication can be synced back with the publisher indicating that the publisher should begin sending event-level impression data to the TEE endpoint. Where appropriate, the same authentication can be used to begin pulling aggregate campaign data from the publisher via an automated cost data import function.

Data can be periodically transferred from the publishers to the TEE in response to the TEE generating requests for data. The TEE can include in the request indications of specific reporting data to be returned to the TEE. This period can, in some examples, be daily or hourly.

The returned reporting data can be ingested and, in some embodiments, the TEE can map the imported reporting data to dimensions or metrics usable by the content provision platform. This allows the content provision platform to properly display impressions data from non-compatible third-party platforms to users seamlessly. In some embodiments, dimensions can include the date, an ID of the advertising campaign, a campaign data name, a community, and a group data bid type. The metrics can include impressions, clicks, and spending data associated with content items. This data can then be stored in a database of the content provision platform for later use.

In some embodiments, users of the content provision platform can request reports. The content provision platform can access the database to retrieve the imported, processed reporting data to generate reports, including user interface elements summarizing reporting data and providing analysis of content item impressions based on the reporting data.

Credit attribution for impressions can be a valuable statistic for understanding which impressions are making the most impact and where that impact is the greatest. For example, attributing credit for an impression on a website can involve determining which content item directly or indirectly lead to a conversion for the content provider.

In some embodiments, the TEE can be only arbiter of attribution, allocating credit across the full set of visible touchpoints and returning these allocations aligned with aggregate outputs. In other embodiments, the TEE can perform an initial credit allocation which is exported as an input into a final attribution calculation performed in the content provision platform.

In some embodiments, the TEE or the advertising system can utilize machine-learned models to process imported data to determine actions to take for the advertiser. For example, the machine-learned model can take as input reporting data and output recommendations for strategic placement of content items, such as recommending which content items should be prioritized for presentation and where these content items make the most impact for conversions or impressions.

XC and PP unification offers several significant benefits, both personal and technical, across content provision platforms. For example, it allows for decoupling content provision platform and campaign management platform product features from attribution perimeters and instead be intentional about surfacing optimal content items experiences across data sources based on content provider use-cases or segmentation. In another example, in cases where measurement use-cases overlap across advertising platforms and campaign management platforms, consistent reporting can be guaranteed. In a further example, as the number of attributable touchpoints increases, engineering and infrastructure overhead can be minimized, as these touchpoints just need to be added to the XC perimeter instead of requiring separate efforts for XC and PP. This can reduce the need for additional processing power, memory, and network bandwidth for content provision platforms. The use of the TEE as a singular software layer for the handling of impression and conversion data can reduce the need for specialized software and/or hardware for the translation of data from multiple, disconnected platforms, which can in turn aid users of content provision platforms and/or campaign management platforms from having to utilize multiple computing platforms or devices to handle data intake and processing. Furthermore, through the use of the TEE, users can better operate content provision systems and/or campaign management platforms through computing devices with lower computational ability, such as smartphones, without performance degradation, as the TEE performs the majority of the processing needs for data translation and aggregation before providing meaningful and useful data visualizations related to the individual user use cases for the data. This enables users to quickly and accurately digest the most critical data for different decision-making processes in real-time without requiring large computational overhead to handle processing large data sets and data translation between formats for ease of understanding.

With reference now to the Figures, example embodiments of the present disclosure will be discussed in further detail.

### Example Model Arrangements

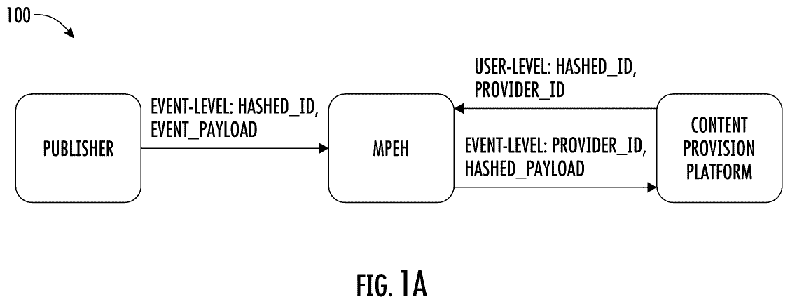

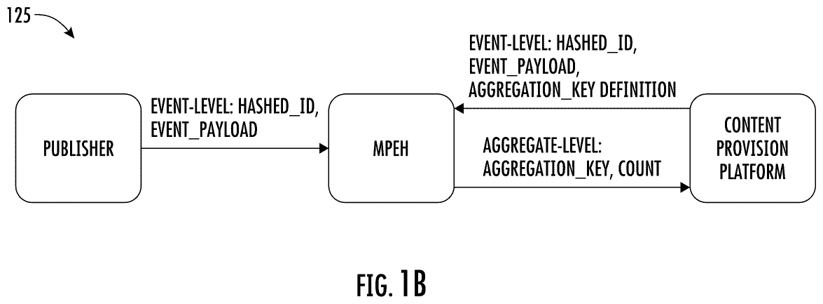

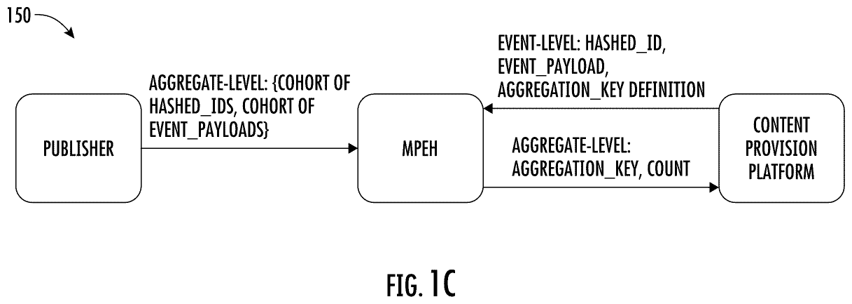

FIG. 1A depicts a first data flow 100 according to example embodiments of the present disclosure. The first data flow 100 illustrates the TEE receiving user level data from the content provision platform. The user level data can include a hashed ID of a particular content item or content campaign and an internal ID and can specify what type of data to retrieve from a data source, such as a publisher of content items for the content provider. The TEE can receive from the publisher event-level impression data identifying one or more impression events associated with the identified content items or content campaigns. The event-level impression data can include a hashed ID of the content item or content campaign and event payload data, which can be indicative of the number, types, and/or attributions of the impression data for a particular content item or content campaign. The TEE can process the event-level impression data to generate usable data for the measurement platform and then pass the data to the platform for storage in a database.

FIG. 1B depicts a second data flow 125 according to example embodiments of the present disclosure. In the second data flow 125, the TEE receives a hashed ID identifying a content item or content campaign and an event payload. The TEE can also receive an aggregation key definition from the content provision platform which defines how event-level impression data should be aggregated from one or more data sources, such as the publisher. The TEE then requests data from the publisher and receives event-level impression data back from the publisher. The event-level impression data can include a hashed ID of the content item or content campaign and event payload data, which can be indicative of the number, types, and/or attributions of the impression data for a particular content item or content campaign. The TEE can process the event-level impression data to “translate” the event-level data or generate usable data for the content provision platform and then pass the data to the platform for storage in a database. In some embodiments, the TEE can also send aggregation data, such as a count, back to the content provision platform. The aggregation data can be indicative of data related to the aggregation key provided to the TEE, such as a number of results that matched the aggregation key.

FIG. 1C depicts a third data flow 150 according to example embodiments of the present disclosure. In the third data flow 150, the TEE receives a hashed ID identifying a content item or content campaign and an event payload. The TEE can also receive an aggregation key definition from the measurement platform which defines how event-level impression data should be aggregated from one or more data sources, such as the publisher. The TEE then requests data from the publisher and receives back aggregate-level data that illustrates an aggregation of different content items or content campaigns (represented by a cohort of hashed IDs) and an event payload associated with each of the different content items or content campaigns. The TEE can process the aggregate-level data to generate usable data for the content provision platform and then pass the data to the platform for storage in a database. In some embodiments, the TEE can also send aggregation data, such as a count, back to the content provision platform. The aggregation data can be indicative of data related to the aggregation key provided to the TEE, such as a number of results that matched the aggregation key.

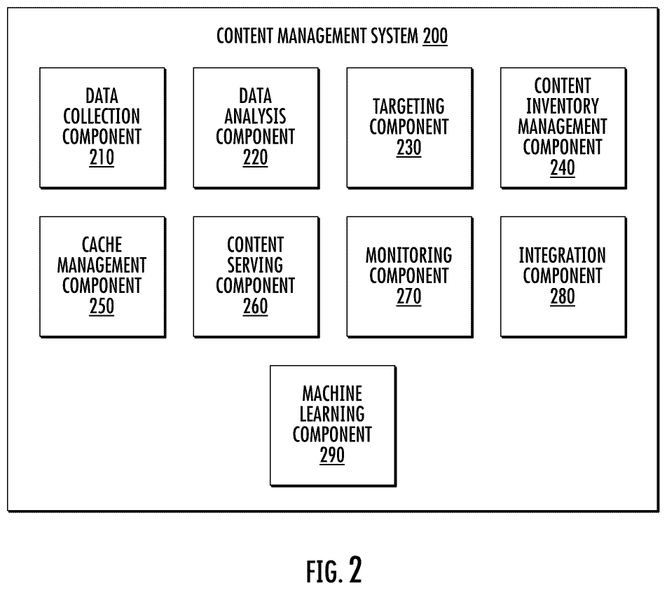

FIG. 2 depicts a block diagram of a content management system 200 according to example embodiments of the present disclosure. The content management system 200 include a data collection component 210, a data analysis component 220, a targeting component 230, a content inventory management component 240, a cache management component 250, a content serving component 260, a monitoring component 270, an integration component 280, and a machine learning component 290. In some embodiments, the content management system 200 can be an advertising platform and/or a combination of an advertising platform and an TEE

The components 210-290 can communicate with each other and work together to collect, process, store, and serve content to users. By orchestrating components 210-290 effectively, the content management system 200 can deliver advertising content items to users in a timely and relevant manner, maximizing advertising campaign effectiveness while minimizing operational overhead.

The data collection component 210 can receive raw data from various sources, including websites, mobile apps, content campaign management systems, and third-party data sources. The raw data can include user interactions, browsing history, search queries, demographics, location information, cookie information, and device types among other types of raw data.

In some embodiments, the raw data can include data indicative of impressions generated by content items owned by the content provider provided at the data source. For example, if a visual content item was displayed on an instance of a web page owned by the source, an impression can be generated by the source indicating that the content item was presented to a user of the data source. A number of impressions for different content items can be tracked by the data source and provided back to the data collection component 210. Other raw data associated with the impressions, such as demographic data, click-through data, viewing data, and the like can also be sent from the data source to the data collection component 210.

In some embodiments, obtaining the raw data can include providing credentials to access the data source from which the raw data is obtained. For example, certain data sources may require login credentials or other security credentials before allowing the data collection component 210 to receive the raw data from the data source. The data collection component 210 can obtain the required credentials from a user or from a credential storage location and provide the required credentials to the data source for access to the raw data.

In some embodiments, obtaining the raw data can include utilizing an application programming interface (“API”) call at the data source to retrieve the raw data from the data source. This API call can define parameters for data to be retrieved, such date, time, location where content was displayed, and the like. The returned data can include the defined parameters and one or more other parameters.

The data analysis component 220 can process and analyze the raw data to generate analysis data. The analysis data can include meaningful insights, hints, and relevant information about the impressions garnered by the provision of content items to data sources. The data analysis component 220 can involve real-time stream processing as well as batch processing of historical data. Techniques such as machine learning, data mining, and statistical analysis can be employed to derive preferences, interests, and behavior patterns of users, impression patterns about content items, and the like.

In some embodiments, the data analysis component 220 can perform data conversion on the received raw data to a format usable by the content management system 200. For example, different platforms or data sources can provide raw data to the content management system 200 in different reporting formats, data formats, and the like. The data analysis component 220 can convert the received data into formats or metrics usable by the content management system 200 for reporting purposes.

The targeting component 230 can determine which content item to serve each user based on the process data generated by the data analysis component 220. In some instances, the targeting component 230 can match user attributes (e.g., demographics, interests) with targeting criteria specified by the content provider. Additionally, the targeting component 230 can utilize machine-learned models, algorithms and rules to select the most relevant content item for each user in real-time.

The content inventory management component 240 can manage the inventory of available content items that can be served to users. The content inventory management component 240 can store information about content item creatives, targeting criteria, bidding information, and campaign budgets. Additionally, the content provider can interact with the content inventory management component 240 to upload and manage their content item campaigns to, for example, data sources.

The cache management component 250 includes a content item targeting cache. The content item targeting cache stores precomputed targeting decisions and content item creatives. The cache management component optimizes content item serving by reducing latency and improving scalability. Additionally, the content management system 200 can include cache eviction policies and strategies that are implemented to manage cache size and ensure freshness of data.

The content serving component 260 can serve content items to users in real-time. In some instances, the content serving component 260 can serve a content item stored in the cache management component 250 based on the targeting decisions. The content serving component 260 can interfaces with websites, mobile apps, or other digital platforms where the content items are displayed.

The monitoring component 270 can provide monitoring, logging, and reporting capabilities to track system performance, content delivery metrics, and compliance with regulations. The monitoring component 270 can generate alerts and notifications for issues such as downtime, performance degradation, or policy violations.

The integration component 280 can facilitate integration with external systems such as demand-side platforms, data management platforms, content item exchanges, and content item networks. APIs and standard protocols can be used for seamless communication between different components of the content tech ecosystem.

The machine learning component 290 can facilitate analysis of data using one or more machine-learned models. For example, the machine-learned models can take as input reporting data and output recommendations for strategic placement of content items, such as recommending which content items should be prioritized for presentation and where these content items make the most impact for conversions or impressions.

### Example Methods

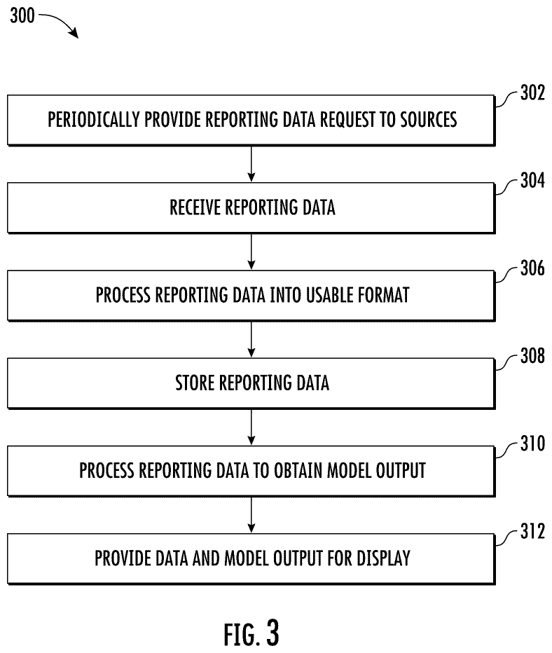

FIG. 3 depicts a flow chart diagram of an example method 300 to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

In some embodiments, the computing system can provide content to a plurality of data sources, wherein the content is selected from a plurality of content stored in a database. This content can then be presented on the plurality of data sources.

At 302, a computing system can periodically provide a reporting data request to each data source of the plurality of data sources. The reporting data request can request data indicative of a number of impressions associated with the content provided to the plurality of data sources by the computing system.

In some embodiments, providing the reporting data request can include providing authentication credentials to each data source of the plurality of data sources. By providing authentication credentials to data sources, the computing system can both indicate that the computing system is a trusted system to send data to, and can indicate user-account specific data to access.

In some embodiments, providing the authentication credentials can include establishing an authenticated connection between the computing system and each data source of the plurality of data sources based on the providing of the authentication credentials to each data source of the plurality of data sources. The reporting data can then be received over the authenticated connection.

In some embodiments, the authentication credentials for a respective data source are unique to the respective data source. For example, each data source may require a unique username, password, two-factor authentication, or another specific method of verifying user identity, instead of shared credentials for each data source.

In some embodiments, providing authentication credentials to each data source can include providing a token allowing the sending of impression data to the computing system. This token can identify an TEE of the computing system as a data destination for impression data and can be used to securely pass data between the data source and the TEE.

In some embodiments, the authentication credentials can include a terms of service. It can be advantageous to allow data sources to accept a terms of service before sending data to the computing system so that administrators of the data source can understand where and how the data is being used and provide their consent for use of the data. In these embodiments, the token can be provided once a publisher accepts the terms of service.

At 304, the computing system can receive reporting data from the plurality of data sources in response to the reporting data request. The received data can be raw data from the plurality of data sources, or data that requires further processing and refinement before interpretation.

In some embodiments, the reporting data can event-level impression data, or data indicative of how, when, where, how frequently, how long, and/or why a user viewed a particular content item, where each viewing of the content item can be separated out as a distinct event data item, or impression. In some embodiments, each event-level impression data item can include an event-level hash ID and an event payload. The event-level hash ID can uniquely identify the event or impression, and the event payload can include data descriptive of the event or impression. In some embodiments, the event payload comprises data indicative of credit attribution for at least one impression described by the event-level impression data.

In some embodiments, the reporting data includes credit attribution data, or data that indicates what content channel, medium, location, campaign, or the like should be given credit for one or more conversions.

At 306, the computing system can process the reporting data into a data format usable by the database. Processing the data into the data format can include performing any number of data processing procedures, such as validating the data, sorting data, summarizing data, aggregating data, classifying data, and the like. In some embodiments, processing the reporting data can include converting the reporting data from a format incompatible for use by the computing system to a format compatible for use by the computing system. For example, certain received data may be in a first format, such as XML data or CSV data. The reporting capabilities of the computing system may not be able to process data in these formats. Therefore, the computing system may convert, translate, or transform the data from the first format into a usable format by the reporting capabilities of the computing system. In some embodiments, the converting can be performed based on which data source of the plurality of data sources the reporting data was received from. For example, a first data source may send first data in a first format, and the computing system can convert the first data from the first format into a usable format. A second data source may send second data in a second format, and the computing system can convert the second data from the second format into the usable format.

In some embodiments, computing system further comprises a trusted execution environment (TEE) software layer implemented by a second set of instructions stored in the non-transitory, computer-readable medium. The TEE can be a software layer that exists on the computing system between publishers (e.g. social media sites, news sites, etc.) or other data sources for data associated with impressions of displayed content items and content provision platforms or campaign management platforms. The TEE can receive the reporting data and process the reporting data into the data format usable by the database.

In some embodiments, processing the reporting data can include processing event-level impression data to generate an attribution data payload for storage in the database.

In some embodiments, the event-level impression data can include data indicative of an aggregation of data from at least one data source of the plurality of data sources.

In some embodiments, the aggregation of data can include a plurality of event hashed identifications and a plurality of event payloads, wherein each event payload of the plurality of event payloads is associated with one event hashed identification of the plurality of event hashed identifications.

At 308, the computing system can store the reporting data in the database.

At 310, in response to receiving a request from a user to generate a report, the computing system can process the reporting data stored in the database using a machine-learned model to generate a model output. The model output can be indicative of one or more actions a user can take based on the reporting data. For example, a machine-learned model can process the reporting data and provide a classification of the effectiveness of the reporting data in various channels based on the impressions made by the data in those channels. In another example, a machine-learned model can make a recommendation for budgeting for a new advertising campaign based on the reporting data, such as suggesting focusing on particular channels, content types, and the like based on impression data from current and/or past content campaigns.

At 312, the computing system can output at least a portion of the reporting data and the model output for display to the user.

### Example Devices and Systems

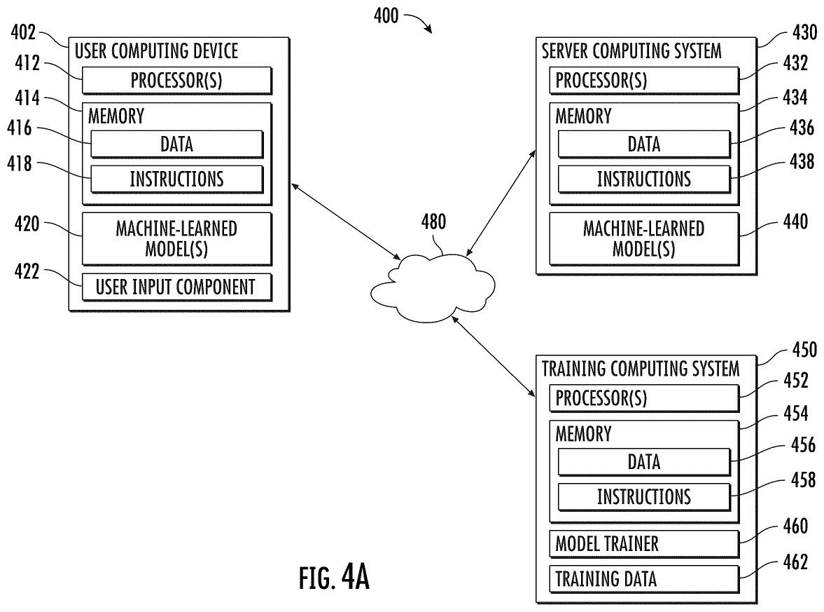

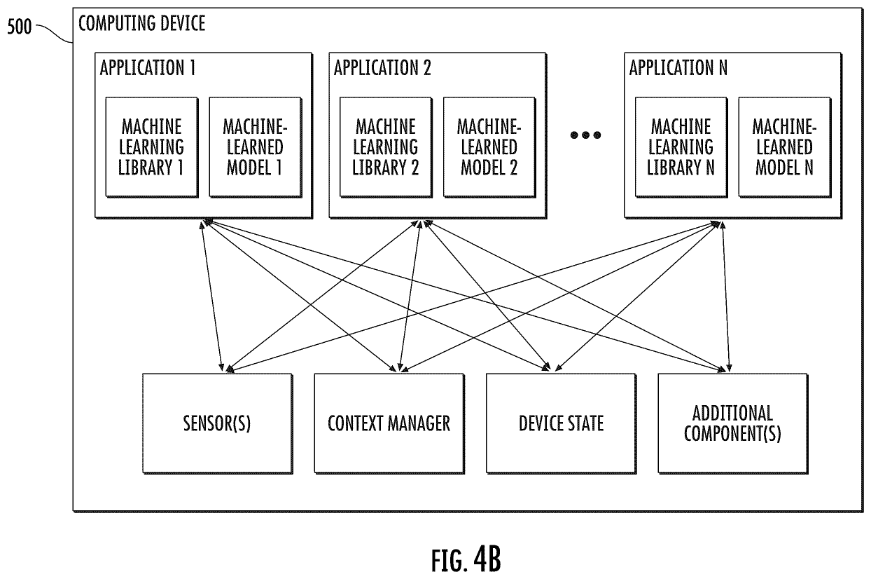

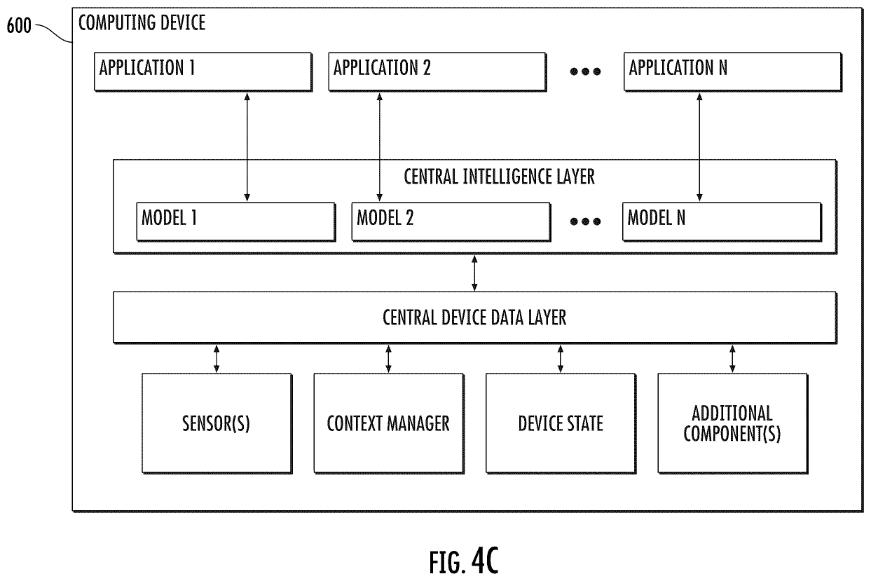

FIG. 4A depicts a block diagram of an example computing system 400 according to example embodiments of the present disclosure. The system 400 includes a user computing device 402, a server computing system 430, and a training computing system 450 that are communicatively coupled over a network 480.

The user computing device 402 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 402 includes one or more processors 412 and a memory 414. The one or more processors 412 can be any suitable processing device (e.g., a processor core, a microprocessor, an ASIC, an FPGA, a controller, a microcontroller, etc.) and can be one processor or a plurality of processors that are operatively connected. The memory 414 can include one or more non-transitory computer-readable storage media, such as RAM, ROM, EEPROM, EPROM, flash memory devices, magnetic disks, etc., and combinations thereof. The memory 414 can store data 416 and instructions 418 which are executed by the processor 412 to cause the user computing device 402 to perform operations.

In some implementations, the user computing device 402 can store or include one or more models 420. For example, the models 420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more models 420 can be received from the server computing system 430 over network 480, stored in the user computing device memory 414, and then used or otherwise implemented by the one or more processors 412. In some implementations, the user computing device 402 can implement multiple parallel instances of a single model 420.

Additionally or alternatively, one or more models 440 can be included in or otherwise stored and implemented by the server computing system 430 that communicates with the user computing device 402 according to a client-server relationship. For example, the models 440 can be implemented by the server computing system 440 as a portion of a web service. Thus, one or more models 420 can be stored and implemented at the user computing device 402 and/or one or more models 440 can be stored and implemented at the server computing system 430.

The user computing device 402 can also include one or more user input components 422 that receives user input. For example, the user input component 422 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage media, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices. In instances in which the server computing system 430 includes plural server computing devices, such server computing devices can operate according to sequential computing architectures, parallel computing architectures, or some combination thereof.

As described above, the server computing system 430 can store or otherwise include one or more models 440. For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 402 and/or the server computing system 430 can train the models 420 and/or 440 via interaction with the training computing system 450 that is communicatively coupled over the network 480. The training computing system 450 can be separate from the server computing system 430 or can be a portion of the server computing system 430.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage media, such as RAM, ROM, EEPROM, EPROM, flash memory devices, magnetic disks, etc., and combinations thereof. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that trains the machine-learned models 420 and/or 440 stored at the user computing device 402 and/or the server computing system 430 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained.

In particular, the model trainer 460 can train the models 420 and/or 440 based on a set of training data 462.

In some implementations, if the user has provided consent, the training examples can be provided by the user computing device 402. Thus, in such implementations, the model 420 provided to the user computing device 402 can be trained by the training computing system 450 on user-specific data received from the user computing device 402. In some instances, this process can be referred to as personalizing the model.

The model trainer 460 includes computer logic utilized to provide desired functionality. The model trainer 460 can be implemented in hardware, firmware, and/or software controlling a general purpose processor. For example, in some implementations, the model trainer 460 includes program files stored on a storage device, loaded into a memory and executed by one or more processors. In other implementations, the model trainer 460 includes one or more sets of computer-executable instructions that are stored in a tangible computer-readable storage medium such as RAM, hard disk, or optical or magnetic media.

The network 480 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

FIG. 4A illustrates one example computing system that can be used to implement the present disclosure. Other computing systems can be used as well. For example, in some implementations, the user computing device 402 can include the model trainer 460 and the training dataset 462. In such implementations, the models 420 can be both trained and used locally at the user computing device 402. In some of such implementations, the user computing device 402 can implement the model trainer 460 to personalize the models 420 based on user-specific data.

FIG. 4B depicts a block diagram of an example computing device 500 that performs according to example embodiments of the present disclosure. The computing device 500 can be a user computing device or a server computing device.

The computing device 500 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 600 that performs according to example embodiments of the present disclosure. The computing device 600 can be a user computing device or a server computing device.

The computing device 600 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 600.

The central intelligence layer can communicate with a central device data layer. The central device data layer can be a centralized repository of data for the computing device 600. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, comprising:
one or more processors;
a database; and
a non-transitory, computer-readable medium storing instructions that, when executed by the one or more processors, cause the one or more processors to perform operations, the operations comprising:
periodically providing a reporting data request to each data source of a plurality of data sources, the reporting data request requesting data indicative of a number of impressions associated with content provided to the plurality of data sources;
receiving reporting data from the plurality of data sources in response to the reporting data request;
processing the reporting data into a data format usable by the database;
storing the reporting data in the database; and
in response to receiving a request from a user to generate a report:
processing the reporting data stored in the database using a machine-learned model to generate a model output, wherein the model output is indicative of one or more actions a user can take based on the reporting data; and
outputting at least a portion of the reporting data and the model output for display to the user.

2. The computing system of claim 1, the operations further comprising providing the content to the plurality of data sources, wherein the content is selected from a plurality of content stored in the database.

3. The computing system of claim 1, wherein processing the reporting data comprises converting the reporting data from a format incompatible for use by the computing system to a format compatible for use by the computing system.

4. The computing system of claim 3, wherein the converting is performed based on which data source of the plurality of data sources the reporting data was received from.

5. The computing system of claim 1, the operations further comprising:
providing authentication credentials to each data source of the plurality of data sources; and
creating an authenticated connection between the computing system and each data source of the plurality of data sources based on the providing of the authentication credentials to each data source of the plurality of data sources; wherein the reporting data is received over the authenticated connection.

6. The computing system of claim 5, wherein the authentication credentials for a respective data source is unique to the respective data source.

7. The computing system of claim 5, wherein providing authentication credentials to each data source includes providing a token allowing sending of impression data to the computing system.

8. The computing system of claim 7, wherein the authentication credentials include a terms of service, wherein the token is provided once a publisher accepts the terms of service.

9. The computing system of claim 1, wherein the reporting data is event-level impression data.

10. The computing system of claim 9, wherein the event-level impression data includes an event-level hash ID and an event payload.

11. The computing system of claim 10, wherein the event payload comprises data indicative of credit attribution for at least one impression described by the event-level impression data.

12. The computing system of claim 9, wherein the computing system further comprises a multi-party event hub software layer implemented by a second set of instructions stored in the non-transitory, computer-readable medium.

13. The computing system of claim 12, wherein the multi-party event hub software layer receives the reporting data.

14. The computing system of claim 13, wherein the multi-party event hub software layer processes the reporting data into the data format usable by the database.

15. The computing system of claim 14, wherein processing the reporting data includes processing the event-level impression data to generate an attribution data payload for storage in the database.

16. The computing system of claim 14, wherein the event-level impression data includes data indicative of an aggregation of data from at least one data source of the plurality of data sources.

17. The computing system of claim 16, wherein the aggregation of data includes a plurality of event hashed identifications and a plurality of event payloads, wherein each event payload of the plurality of event payloads is associated with one event hashed identification of the plurality of event hashed identifications.

18. The computing system of claim 1, wherein the reporting data includes credit attribution data.

19. A computer-implemented method, the method comprising:
periodically providing, by one or more processors of a computing system, a reporting data request to each data source of a plurality of data sources, the reporting data request requesting data indicative of a number of impressions associated with content provided to the plurality of data sources;
receiving, by the one or more processors, reporting data from the plurality of data sources in response to the reporting data request;
processing, by the one or more processors, the reporting data into a data format usable by a database;
storing, by the one or more processors, the reporting data in the database; and
in response to receiving a request from a user to generate a report:
processing, by the one or more processors, the reporting data stored in the database using a machine-learned model to generate a model output, wherein the model output is indicative of one or more actions a user can take based on the reporting data; and
outputting, by the one or more processors, at least a portion of the reporting data and the model output for display to the user.

20. A non-transitory, computer-readable medium storing instructions that, when executed by one or more processors, cause the one or more processors to perform operations, the operations comprising:
periodically providing a reporting data request to each data source of the plurality of data sources, the reporting data request requesting data indicative of a number of impressions associated with content provided to the plurality of data sources;
receiving reporting data from the plurality of data sources in response to the reporting data request;
processing the reporting data into a data format usable by the database;
storing the reporting data in the database; and
in response to receiving a request from a user to generate a report:
processing the reporting data stored in the database using a machine-learned model to generate a model output, wherein the model output is indicative of one or more actions a user can take based on the reporting data; and
outputting at least a portion of the reporting data and the model output for display to the user.
